(19) United States
(12) Patent Application Publication
(10) Pub. No.: US 2025/0315435 A1
(43) Pub. Date: Oct. 9, 2025

(54) SYSTEM AND METHOD FOR RESPONDING TO QUERIES

(71) Applicant: Yahoo Assets LLC, New York, NY (US)

(72) Inventors: Ilan Ben-Bassat, Tel-Aviv (IL); Sanika Shirwadkar, Milpitas, CA (US); Kenneth Sebastian, Santa Clara, CA (US); Gregory Antonovsky, Brooklyn, NY (US)

(21) Appl. No.: 18/627,500

(22) Filed: Apr. 5, 2024

(51) Int. Cl. G06F 16/2455

(52) U.S. Cl. CPC G06F 16/24565

(57) ABSTRACT

One or more computing devices and/or methods are provided. In an example, a feature-sensitive query may be received. A first language model may be used to generate an executable feature constraint determination command based upon a set of information including the feature-sensitive query. The executable feature constraint determination command may be executed to determine a feature constraint associated with the feature-sensitive query. The data structure may be analyzed based upon the feature constraint to identify a subset of data, of the data structure, relevant to the feature constraint. A response to the feature-sensitive query may be generated based upon the subset of data.

### BACKGROUND

Many services, such as websites, applications, etc. may provide platforms for navigating through various media items, datasets, etc. For example, a user may interact with a search interface to find search results for a query.

### SUMMARY

In accordance with the present disclosure, one or more computing devices and/or methods are provided. In an example, a time-sensitive query may be received. A first language model may be used to generate an executable time constraint determination command based upon a set of information comprising the time-sensitive query. The executable time constraint determination command may be executed to determine a time constraint associated with the time-sensitive query. The data structure may be analyzed based upon the time constraint to identify a subset of data, of the data structure, relevant to the time constraint. A response to the time-sensitive query may be generated based upon the subset of data.

In an example, a feature-sensitive query may be received. A first language model may be used to generate an executable feature constraint determination command based upon a set of information comprising the feature-sensitive query. The executable feature constraint determination command may be executed to determine a feature constraint associated with the feature-sensitive query. The data structure may be analyzed based upon the feature constraint to identify a subset of data, of the data structure, relevant to the feature constraint. A response to the feature-sensitive query may be generated based upon the subset of data.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method for responding to queries.

FIG. 5A is a component block diagram illustrating an example system for responding to queries, where a first interface is displayed on a first client device.

FIG. 5B is a component block diagram illustrating an example system for responding to queries, where a language model is used to generate a feature constraint determination command based upon a set of information.

FIG. 5C is a component block diagram illustrating an example system for responding to queries, where a command execution module is used to execute a feature constraint determination command to determine a feature constraint.

FIG. 5D is a component block diagram illustrating an example system for responding to queries, where a subset of relevant data is extracted from a data structure based upon a feature constraint.

FIG. 5E is a component block diagram illustrating an example system for responding to queries, where a language model is used to generate a response to a query based upon a subset of relevant data.

FIG. 5F is a component block diagram illustrating an example system for responding to queries, where a representation of a response to a query is displayed on a first client device.

FIG. 6 is an illustration of a scenario featuring an example non-transitory machine readable medium in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

### 1. Computing Scenario

The following provides a discussion of some types of computing scenarios in which the disclosed subject matter may be utilized and/or implemented.

### 1.1. Networking

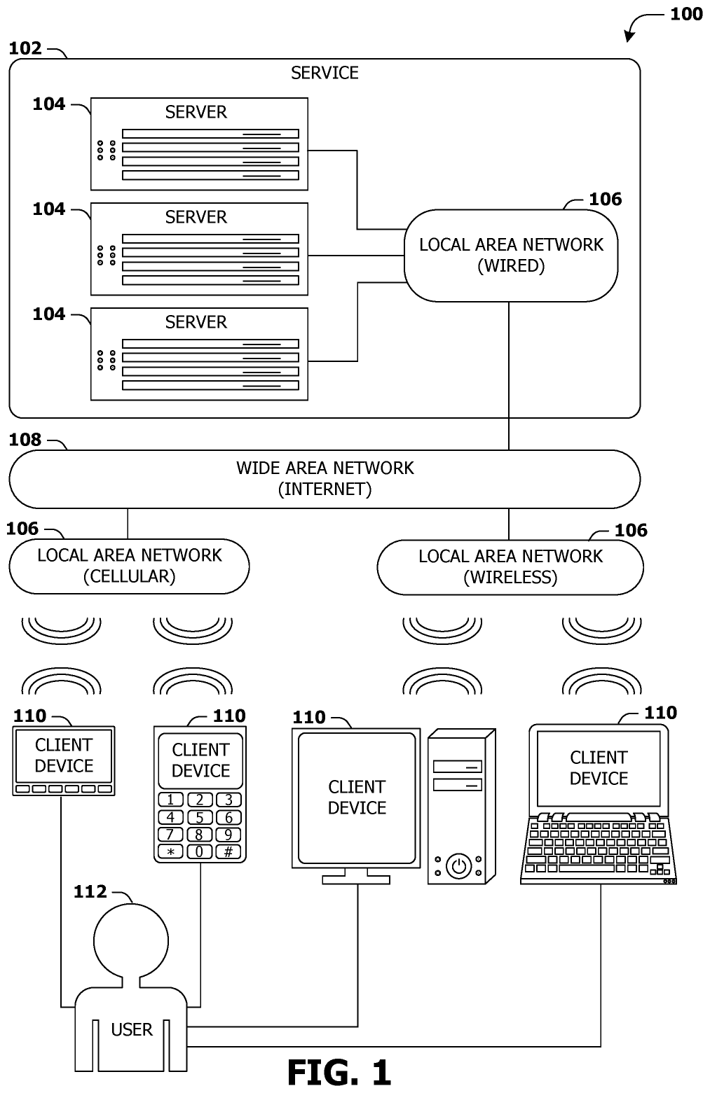

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fiber Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 (and/or via a wired network) provided by a location such as the user's home or workplace (e.g., a WiFi (Institute of Electrical and Electronics Engineers (IEEE) Standard 802.11) network or a Bluetooth (IEEE Standard 802.15.1) personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

### 1.2. Server Configuration

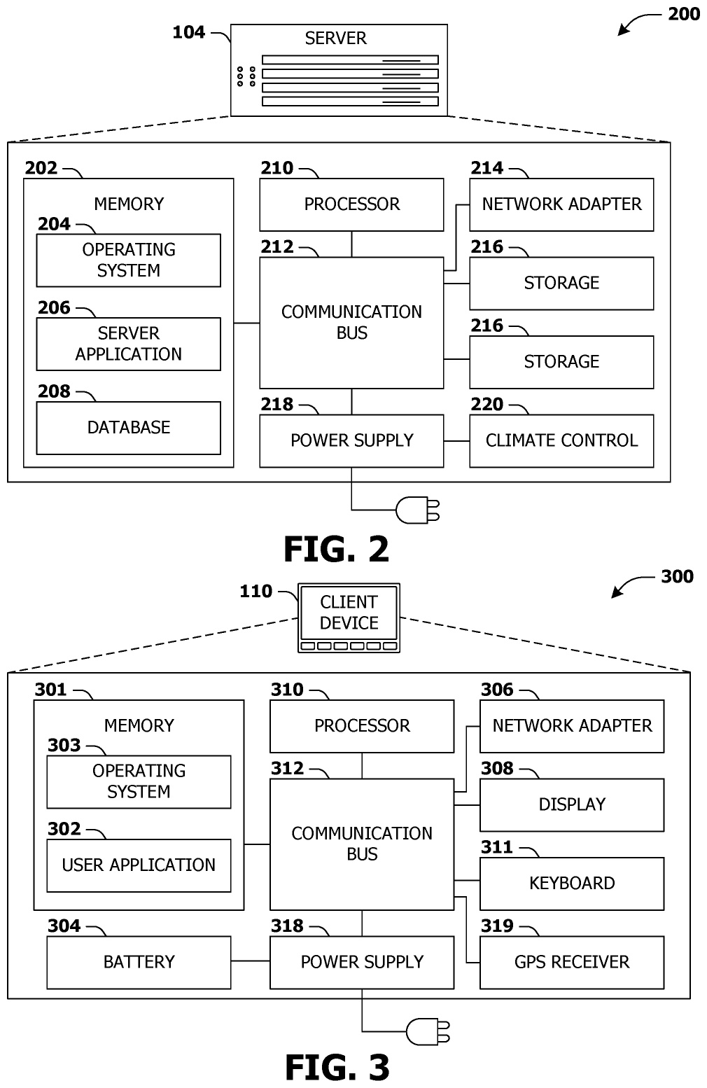

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

### 1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 310 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 311, a mouse, a microphone, a camera, and/or a touch-sensitive component of the display 308; and/or environmental sensors, such as a global positioning system (GPS) receiver 319 that detects the location, velocity, and/or acceleration of the client device 110, a compass, accelerometer, and/or gyroscope that detects a physical orientation of the client device 110. Other components that may optionally be included with the client device 110 (though not shown in the schematic architecture diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

### 2. Presented Techniques

One or more computing devices and/or techniques for responding to queries are provided. In an example, a time-sensitive query may be received from a user. The time-sensitive query may be associated with a time constraint. A first language model may be used to generate an executable time constraint determination command based upon a set of information comprising the time-sensitive query. The executable time constraint determination command may be executed to determine a time constraint associated with the time-sensitive query. The data structure may be analyzed based upon the time constraint to identify (and/or extract) a subset of data, of the data structure, relevant to the time constraint. A response to the time-sensitive query may be generated based upon the subset of data.

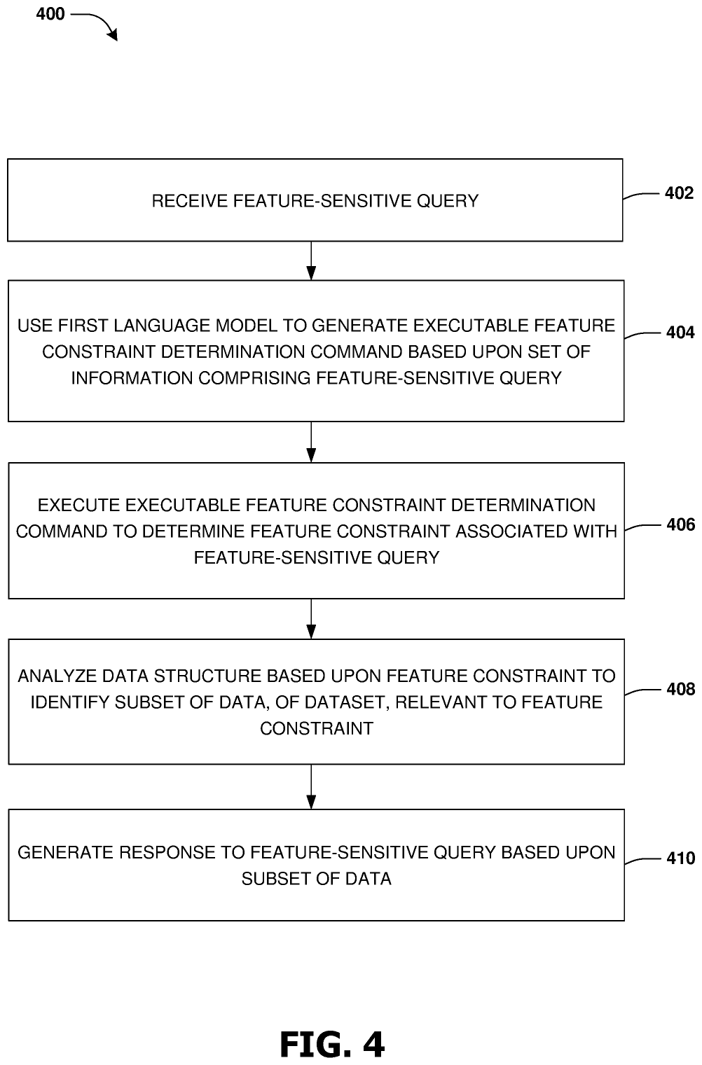

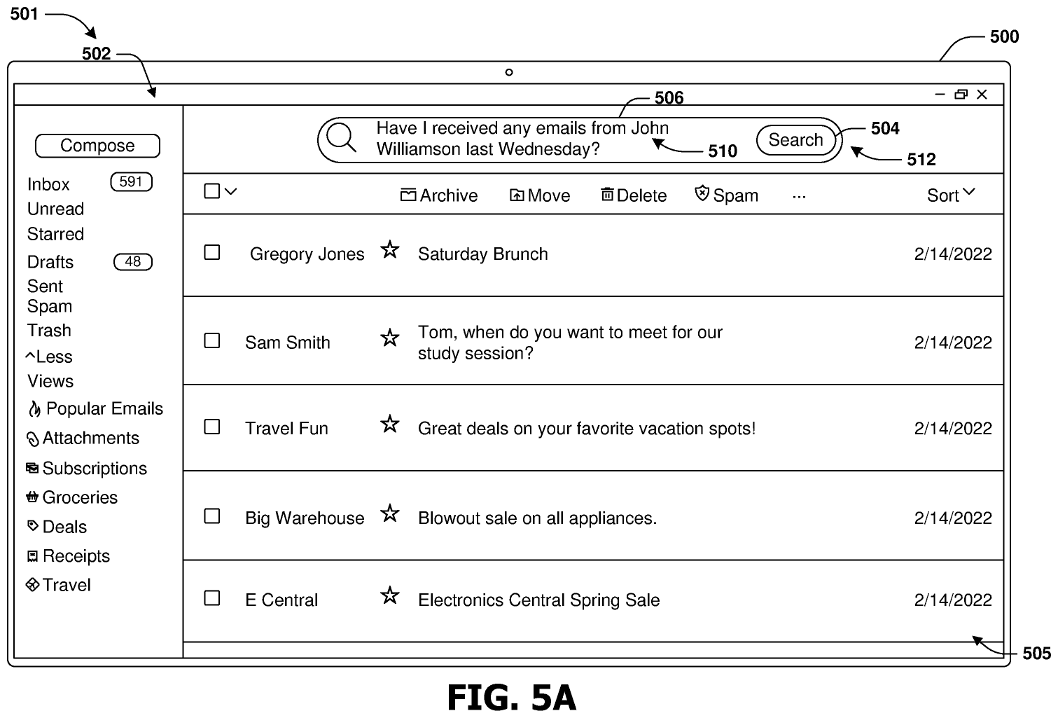

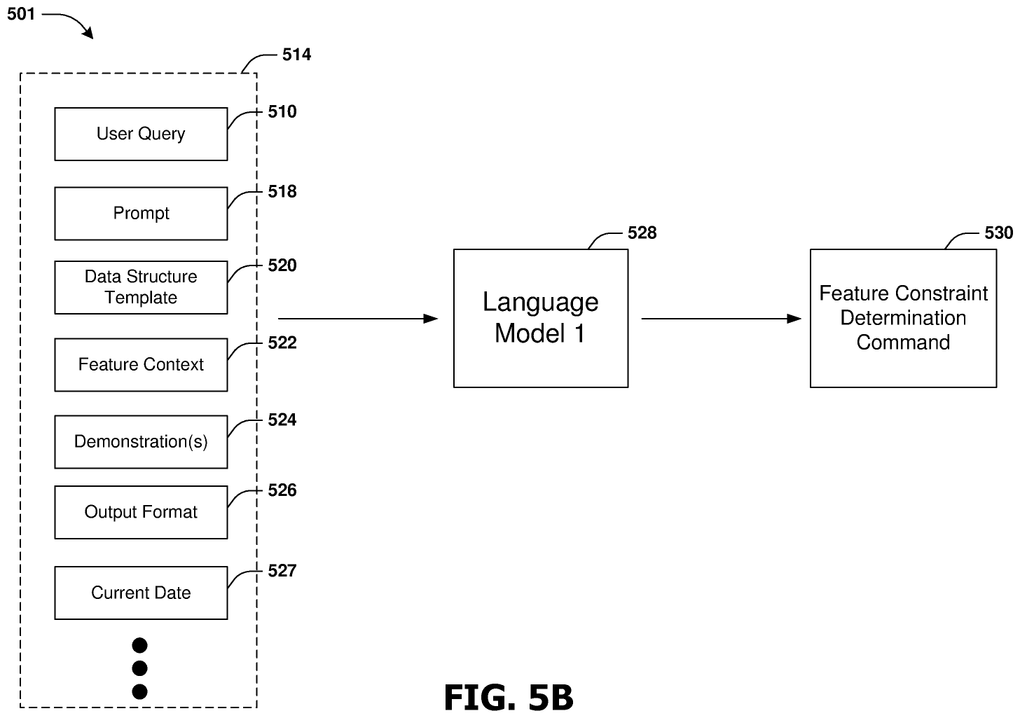

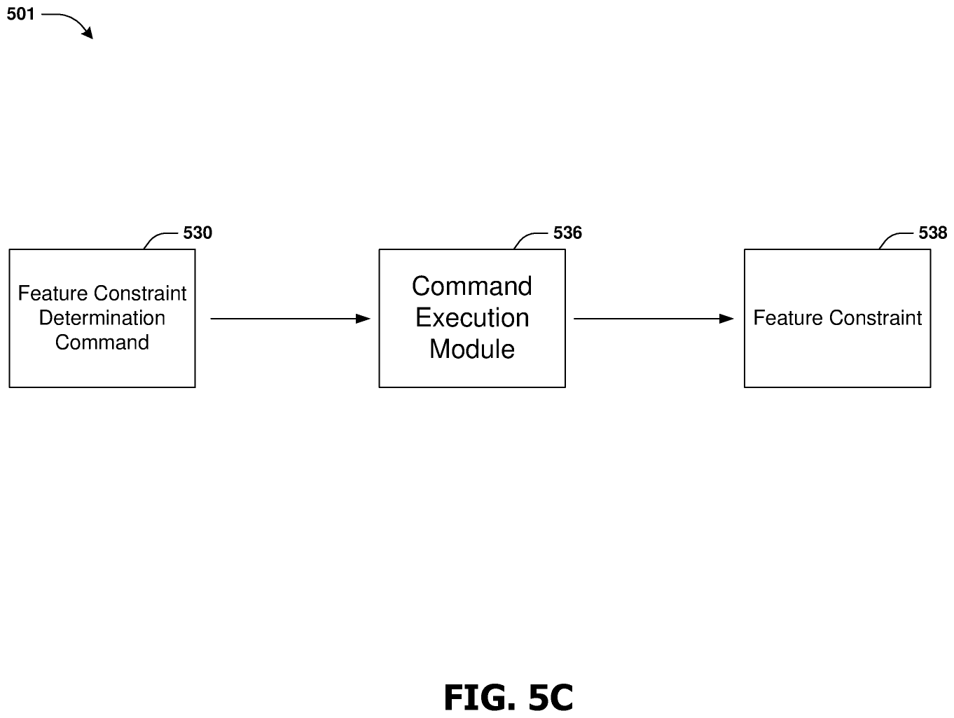

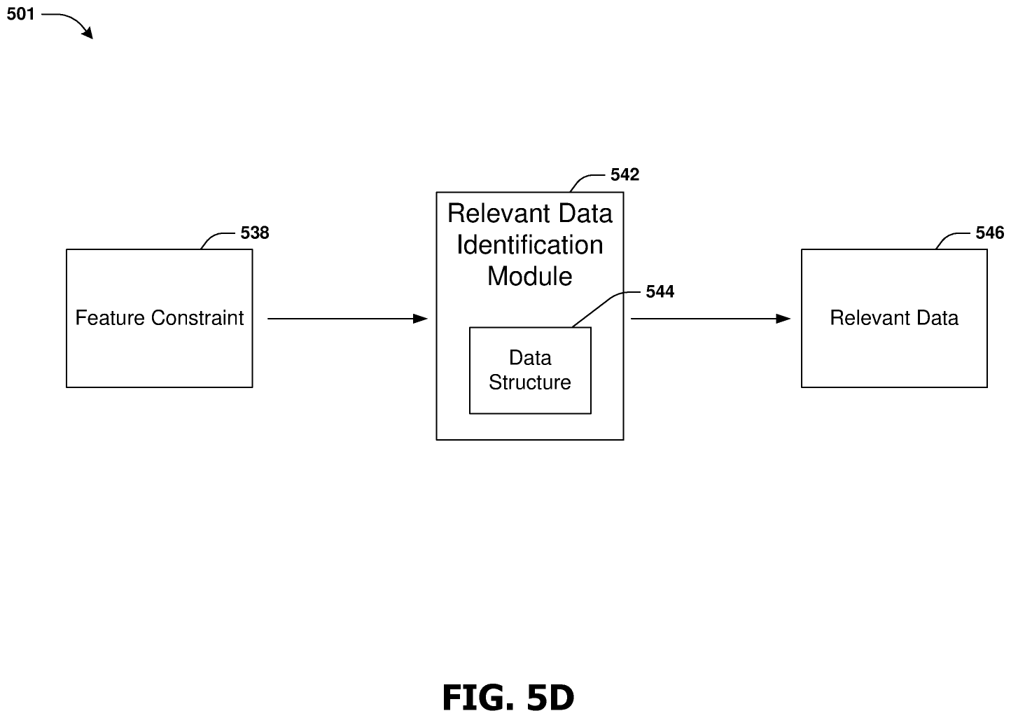

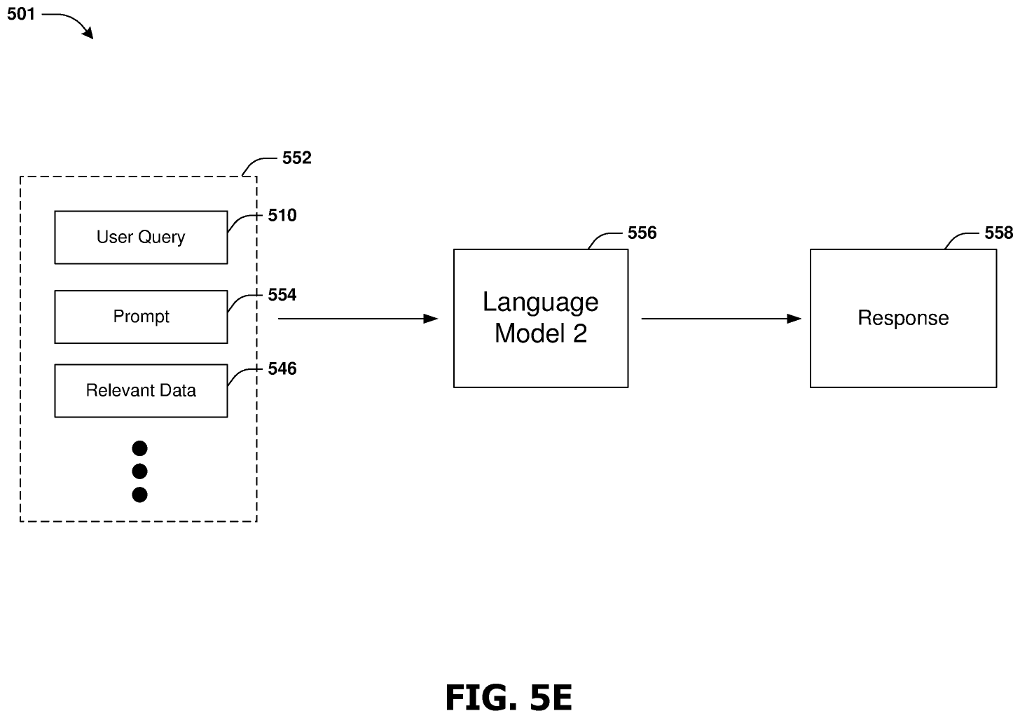

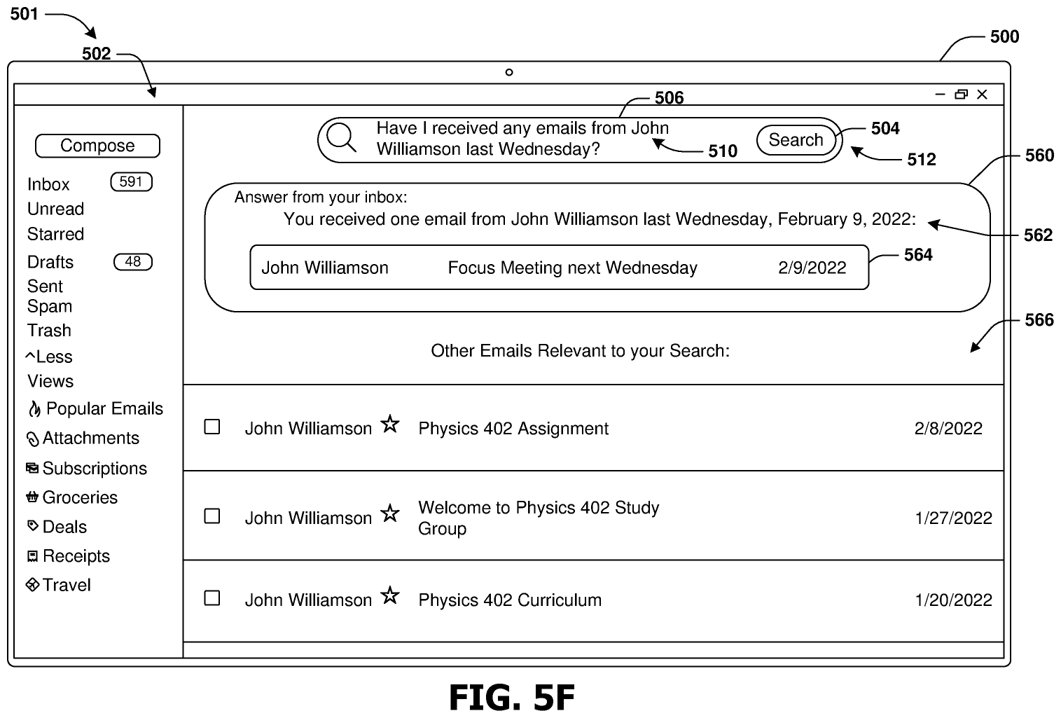

An embodiment of responding to queries is illustrated by an example method 400 of FIG. 4, and is further described in conjunction with a system 501 of FIGS. 5A-5F. In some examples, a content system is provided. A first user, such as user Jill, (and/or a first client device associated with the first user) may access and/or interact with a service, such as an email interface, a browser, software, a website, an application, an operating system, a messaging interface, a music-streaming application, a video application, a news application, etc. that provides a platform for viewing and/or downloading content items (e.g., emails, articles, sets of text, images, audio, videos, etc.) from a server associated with the content system.

At 402, the content system may receive a first query. The first query may be a feature-sensitive query, such as a query that includes a first feature constraint associated with a first feature. In an example, the first feature may correspond to time (e.g., the first query may be a time-sensitive query) and/or the first feature constraint may correspond to a first time constraint (e.g., a period of time to which the first query is relevant). The first query may be received via a first interface displayed on the first client device.

FIG. 5A illustrates the first interface (shown with reference number 502) displayed via the first client device (shown with reference number 500). The first client device 500 may comprise at least one of a phone, a laptop, a computer, a wearable device, a smart device, a television, any other type of computing device, hardware, etc. In an example, the first interface 502 may comprise an email interface. The first interface 502 may be displayed using a browser, a mobile application, etc. of the first client device 500. The first interface 502 may display a list of email items 505. In some examples, email items of the list of email items 505 correspond to emails of an inbox of a first email account associated with the first user. In some examples, in response to a selection of an email item of the list of email items 505, an email associated with the email item may be displayed.

The first interface 502 may comprise a query interface 512 for submitting a query. In some examples, the query interface 512 may comprise a query field 506. For example, the first query (shown with reference number 510) may be entered into the query field 506. In an example, the first query 510 may comprise text (e.g., “Have I received any emails from John Williamson last Wednesday?”). In some examples, the query interface 512 may comprise a search selectable input 504 corresponding to performing a search based upon the first query 510. The content system may receive the first query 510 in response to a selection of the search selectable input 504.

In some examples, the content system may identify a first data structure (for use in responding to the first query 510, for example). In some examples, the first data structure comprises structured data indicative of relations among entities and/or variables. In an example, the first data structure may comprise a relational database. In some examples, the first data structure may comprise a plurality of fields and/or values of the plurality of fields. The first data structure may be stored on one or more data stores (e.g., data storage servers) of the content system.

In some examples, the content system identifies the first data structure based upon the first query 510 and/or user information (e.g., the first email account and/or other user account) associated with the first user and/or the first client device 500. In an example, data that the first user of the first client device 500 is authorized to access may be determined based upon the user information. The first data structure may be identified (for use in responding to the first query 510, for example) based upon a determination that the first user is authorized to access data of the first data structure. Alternatively and/or additionally, in response to determining that the first user is authorized to view one or more sets of data, the first data structure may be generated based upon the one or more sets of data (e.g., the one or more sets of data may be included in the first data structure).

In an example, the first data structure may comprise emails associated with the first email account (e.g., at least one of emails received by the first email account, emails sent by the first email account, emails drafted by the first email account, etc.) and/or data indicative of features associated with the emails. In an example, the first data structure may comprise a set of fields associated with the features comprising at least one of a first field “Time” (e.g., the first field “Time” may be indicative of a time at which an email was sent or received), a second field “Sender” (e.g., the second field “Sender” may be indicative of an email address of a sender of an email), a third field “Recipients” (e.g., the third field “Recipients” may be indicative of one or more email addresses of one or more recipients of an email), a fourth field “Subject” (e.g., the fourth field “Subject” may be indicative of a subject line of an email), etc. The set of fields may be populated with values for emails associated with the first email account. For example, the first field “Time” may be populated with a first time for a first email associated with the first email account (e.g., the first time may correspond to a timestamp corresponding to when the first email was sent or received), a second time for a second email associated with the first email account, etc. The second field “Sender” may be populated with a first sender indication for the first email (e.g., an email address of a sender of the first email), a second sender indication for the second email, etc. The third field “Recipients” may be populated with a first recipient indication for the first email (e.g., one or more email addresses of one or more recipients of the first email), a second recipient indication for the second email, etc.

At 404, the content system may use a first language model to generate a first executable feature constraint determination command based upon a first set of information comprising the first query 510. FIG. 5B illustrates use of the first language model (shown with reference number 528) to generate the first executable feature constraint determination command (shown with reference number 530) based upon the first set of information (shown with reference number 514).

In an example, the first language model 528 may comprise a large language model. The first language model 528 may comprise at least one of a generative artificial intelligence (AI) tool, a neural network, a tree-based model, a machine learning model used to perform linear regression, a machine learning model used to perform logistic regression, a decision tree model, a support vector machine (SVM), a Bayesian network model, a k-Nearest Neighbors (k-NN) model, a K-Means model, a random forest model, a machine learning model used to perform dimensional reduction, a machine learning model used to perform gradient boosting, etc. In some examples, the first language model 528 may be trained using a corpus (e.g., a text corpus). In some examples, the first language model 528 comprises a knowledge base (e.g., a database of resources) comprising at least one of one or more dictionaries, one or more lists of terms, one or more encyclopedias, one or more online encyclopedias, one or more news channel resources, one or more news websites, one or more websites, one or more books, one or more research articles, one or more research article databases, one or more informational databases, etc.

In some examples, the first set of information 514 comprises (i) the first query 510, (ii) a first prompt 518, (iii) a data structure template 520, (iv) a set of feature context information 522, (v) a set of demonstration information 524, (vi) a set of output format information 526, (vii) a current date 527 and/or (viii) other information. In some examples, the first prompt 518 may comprise an instruction to (i) determine whether the first query 510 is associated a feature constraint (e.g., the first feature constraint), and/or (ii) generate the first executable feature constraint determination command 530 that is executable to determine the first feature constraint.

In some examples, the set of output format information 526 may define a format of an output (e.g., an executable feature constraint determination command) output by the first language model 528. In an example, the set of output format information 526 may be indicative of (i) a data management system language (e.g., Structured Query Language (SQL) and/or a different language), (ii) a file and/or data interchange format (e.g., JavaScript Object Notation (JSON) and/or a different format) and/or (iii) a set of keys. The data management system language may correspond to a language (and/or a framework) used by a data management system. The data management system may (i) manage (e.g., update, process, modify, etc.) the first data structure and/or other data structures, (ii) provide users (e.g., authorized users) with access to data of the first data structure and/or other data structures, and/or (iii) allow users (e.g., authorized users) to manipulate data of the first data structure and/or other data structures.

The set of output format information 526 may define one or more constraints on a space of data management operators (e.g., SQL operators and/or other types of data management operators) to be used by the first language model 528 to generate an output (e.g., an executable feature constraint determination command). For example, the set of output format information 526 may define (i) a first set of operators (e.g., data management operators) that the first language model 528 is configured (and/or allowed) to include in an output (e.g., an executable feature constraint determination command) output by the first language model 528, and/or (ii) a second set of operators (e.g., data management operators) that the first language model 528 is not configured (and/or not allowed) to include in an output. The first prompt 518 may comprise an instruction to generate the first executable feature constraint determination command 530 in accordance with the set of output format information 526. In an example, the first language model 528 may generate the first executable feature constraint determination command 530 in accordance with the data management system language, the file and/or data interchange format, the set of keys, the first set of operators (e.g., the first language model 528 may generate the first executable feature constraint determination command 530 to include one or more operators of the first set of operators) and/or the second set of operators (e.g., the first language model 528 may generate the first executable feature constraint determination command 530 to not include any operators of the second set of operators).

In some examples, the content system may generate the data structure template 520 based upon one or more characteristics of the first data structure. In some examples, the one or more characteristics comprise (i) fieldnames of fields of the first data structure, (ii) a format of the first data structure, (iii) a logical configuration of the first data structure, (iv) a visual configuration of the first data structure, and/or (v) a schema (e.g., a database schema) of the first data structure. In some examples, the data structure template 520 is generated such that (i) fieldnames of fields of the data structure template 520 match fieldnames of fields of the first data structure, (ii) a format of the data structure template 520 matches the format of the first data structure, (iii) a logical configuration of the data structure template 520 matches the logical configuration of the first data structure, (iv) a visual configuration of the data structure template 520 matches the visual configuration of the first data structure, and/or (v) a schema of the data structure template 520 matches the schema of the first data structure. In some examples, private information (e.g., emails, user activity information, etc.) is not included in the data structure template 520 (to provide for improved privacy, for example). In some examples, the first prompt 518 may comprise an instruction to generate the first executable feature constraint determination command 530 in accordance with the data structure template 520. In some examples, the first language model 528 may (i) learn characteristics of the first data structure based upon the data structure template 520, wherein the characteristics may include one or more fieldnames of the first data structure, the format of the first data structure, the logical configuration of the first data structure, the visual configuration of the first data structure, and/or the schema of the first data structure, and/or (ii) generate the first executable feature constraint determination command 530 in accordance with the characteristics.

In some examples, the set of feature context information 522 may comprise information associated with the first feature. In an example in which the first feature corresponds to time, the set of feature context information 522 may be indicative of timing information (e.g., calendar context information) comprising (i) one or more definitions of calendar entities comprising at least one of day, week, month, year, etc., (ii) relationships between calendar entities (e.g., number of days in a year, number of days in a week, number of quarters in a year, etc.), (iii) dates of holidays, (iv) one or more definitions of one or more timing terms (e.g., definition of “last weekend”, definition of “next weekend”, etc.), (v) names of days of the week (e.g., Monday, Tuesday, etc.), and/or (vi) other information. In some examples, the first prompt 518 may comprise an instruction to generate the first executable feature constraint determination command 530 in accordance with the set of feature context information 522. In some examples, the first language model 528 may (i) learn contextual information associated with the first feature (e.g., the first language model 528 may learn about a calendar and/or may learn calendar manipulation techniques for calculating the first time constraint) based upon the set of feature context information 522, and/or (ii) generate the first executable feature constraint determination command 530 in accordance with the contextual information.

In some examples, the set of demonstration information 524 may comprise one or more demonstrations. A demonstration of the one or more demonstrations may comprise (i) a query (e.g., an exemplary user query) and (ii) a (desired) output of the first language model 528 in response to the query (e.g., the output may have at least one of (desired) formatting, (desired) operators, (desired) terms, etc.). The first language model 528 may use the set of demonstration information 524 to learn (via a few-shot learning framework, for example) techniques for producing a (desired) output having at least one of (desired) formatting, (desired) operators, (desired) terms, etc. For example, the first language model 528 may use the learned techniques to generate the first executable feature constraint determination command 530.

In some examples, the first prompt 518 may comprise (i) an instruction to convert the first query 510 to a data management statement (e.g., an SQL statement and/or other type of statement), (ii) an instruction to extract one or more feature-related portions (related to the first feature) from the data management statement (e.g., the one or more feature-related portions may correspond to one or more time-related portions when the first feature corresponds to time), and/or (iii) an instruction to generate the first executable feature constraint determination command 530 based upon the one or more feature-related portions. The first language model 528 may generate the first executable feature constraint determination command 530 based upon the one or more feature-related portions.

In some examples, the first language model 528 may be pre-trained and/or fine-tuned using at least some of the first set of information 514. For example, a language model may be trained using the set of output format information 526, the data structure template 520, the set of feature context information 522 and/or the set of demonstration information 524 to generate the first language model 528.

In an example in which the first query 510 comprises text “Have I received any emails from John Williamson last Wednesday?” and/or the first feature corresponds to time, the one or more feature-related portions may comprise a time-related set of text “last Wednesday”. The first language model 528 may identify the time-related set of text “last Wednesday” and/or generate the first executable feature constraint determination command 530 based upon the time-related set of text “last Wednesday” and/or the current date 527. In an example, the current date 527 may correspond to Monday, Feb. 14, 2022. The first language model 528 may determine, based upon the current date 527, that the time-related set of text “last Wednesday” refers to a period of time (e.g., the first time constraint) corresponding to Wednesday, Feb. 9, 2022. Alternatively and/or additionally, the first language model 528 may determine a first function that is usable to determine the period of time (e.g., the first time constraint) given the current date 527. For example, the first function may indicate that the period of time (e.g., the first time constraint) corresponds to five days prior to the current date 527. In some examples, the first executable feature constraint determination command 530 is indicative of the first function. In an example, the first executable feature constraint determination command 530 may comprise “DATE_SUBTRACT (TODAY, 5)” indicating a subtraction operation to subtract five days from the current date 527 (e.g., TODAY) to determine the period of time (e.g., the first time constraint).

At 406, the content system may execute the first executable feature constraint determination command 530 to determine the first feature constraint associated with the first query 510. FIG. 5C illustrates use of a command execution module 536 to execute the first executable feature constraint determination command 530 to determine the first feature constraint (shown with reference number 538). In an example, the command execution module 536 may be implemented via the data management system. In some examples, the data management system and/or the command execution module 536 may operate within a data management framework (e.g., a relational database framework, such as SQL framework) that directly processes the first executable feature constraint determination command 530 to determine the first feature constraint 538. The data management framework may be associated with the data management system language (and/or the command execution module 536 may execute the first executable feature constraint determination command 530 according to the data management system language). Alternatively and/or additionally, the command execution module 536 may comprise a program (e.g., a high-level machine program) that may be used to execute the first executable feature constraint determination command 530. The program may use a programming language (e.g., at least one of Python, Java, etc.) that is different than the data management system language (e.g., SQL).

In an example in which the first query 510 comprises text “Have I received any emails from John Williamson last Wednesday?”, the first feature corresponds to time, and/or the current date 527 corresponds to Monday, Feb. 14, 2022, the first feature constraint 538 (e.g., the first time constraint) may correspond to Wednesday, Feb. 9, 2022. For example, based upon the first executable feature constraint determination command 530, the command execution module 536 may perform the subtraction operation to subtract five days from the current date 527 (e.g., TODAY) to determine that the first feature constraint 538 (e.g., the first time constraint) corresponds to Wednesday, Feb. 9, 2022.

At 408, the content system may analyze the first data structure to identify a first subset of data, of the first data structure, relevant to the first feature constraint 538. FIG. 5D illustrates use of a relevant data identification module 542 to extract the first subset of data (shown with reference number 546) relevant to the first feature constraint 538 from the first data structure (shown with reference number 544). In an example, the relevant data identification module 542 may analyze the first data structure 544 to identify data associated with the first feature constraint 538, and/or may include the data in the first subset of data 546. In an example in which the first feature constraint corresponds to the first time constraint (e.g., a period of time to which the first query 510 is relevant), the relevant data identification module 542 may analyze the first data structure 544 to identify data associated with the first time constraint, and/or may include the data in the first subset of data 546. In an example in which the first data structure 544 comprises emails associated with the first email account, the relevant data identification module 542 may (i) analyze the first data structure 544 to identify one or more first emails that are relevant to the first feature constraint (e.g., the one or more first emails were sent and/or received on Wednesday, Feb. 9, 2022), and/or (ii) include data (from the first data structure 544) associated with the one or more first emails in the first subset of data 546. In an example in which the first feature constraint corresponds to the first time constraint, the one or more first emails may be determined to be relevant to the first time constraint based upon values, of the first field “Time” in the first data structure 544, associated with the one or more first emails matching the first time constraint (e.g., the values associated with the one or more first emails may correspond to times within Wednesday, Feb. 9, 2022).

In some examples, the relevant data identification module 542 filters (e.g., excludes) data that is determined not to be relevant to the first feature constraint from the first subset of data 546. In an example in which the first data structure 544 comprises emails associated with the first email account, the relevant data identification module 542 may (i) analyze the first data structure 544 to identify one or more second emails that are not relevant to the first feature constraint (e.g., the one or more second emails were sent and/or received at times outside of Wednesday, Feb. 9, 2022), and/or (ii) exclude data (from the first data structure 544) associated with the one or more second emails from the first subset of data 546. In an example in which the first feature constraint corresponds to the first time constraint, the one or more second emails may be determined not to be relevant to the first time constraint based upon values, of the first field “Time” in the first data structure 544, associated with the one or more second emails not matching the first time constraint (e.g., the values associated with the one or more first emails may correspond to times outside of Wednesday, Feb. 9, 2022).

At 410, the content system may generate a first response to the first query 510 based upon the first subset of data 546. In some examples, the first response to the first query 510 may be generated using one or more question-answering techniques, such as retrieval-augmented generation (RAG) and/or other techniques. In some examples, the content system may use a second language model to generate the first response based upon a second set of information comprising the first subset of data 546. FIG. 5E illustrates use of the second language model (shown with reference number 556) to generate the first response (shown with reference number 558) based upon the second set of information (shown with reference number 552).

In an example, the second language model 556 may comprise a second large language model. The second language model 556 may comprise at least one of a generative AI tool, a neural network, a tree-based model, a machine learning model used to perform linear regression, a machine learning model used to perform logistic regression, a decision tree model, a SVM, a Bayesian network model, a k-NN model, a K-Means model, a random forest model, a machine learning model used to perform dimensional reduction, a machine learning model used to perform gradient boosting, etc. In some examples, the second language model 556 may be trained using a corpus (e.g., a text corpus). In some examples, the second language model 556 comprises a knowledge base (e.g., a database of resources) comprising at least one of one or more dictionaries, one or more lists of terms, one or more encyclopedias, one or more online encyclopedias, one or more news channel resources, one or more news websites, one or more websites, one or more books, one or more research articles, one or more research article databases, one or more informational databases, etc. In some examples, the second language model 556 is the same as the first language model 528. In some examples, the second language model 556 is different than the first language model 528.

In some examples, the second set of information 552 comprises (i) the first query 510, (ii) a second prompt 554, (iii) the first subset of data 546, and/or (iv) other information. In some examples, the second prompt 554 may comprise an instruction to generate a response (comprising natural language that is human readable, for example) to the first query 510 based upon the first subset of data 546. The second language model 556 may analyze the first subset of data 546 to determine an answer to a query and/or request posed by the first query 510, and/or may generate the first response 558 to comprise a representation of the answer (e.g., a human readable representation of the answer).

In an example in which the first query 510 comprises text “Have I received any emails from John Williamson last Wednesday?”, the second language model 556 may (i) analyze the first subset of data 546 to determine whether the first subset of data 546 is indicative of an email (e.g., any email) from a contact named “John Williamson” and/or (ii) generate the first response 558 based upon the determination. For example, in response to not finding any email from a contact named “John Williamson” in the first subset of data 546, the second language model 556 may generate the first response 558 to include an indication that the first email account has not received any emails from John Williamson in the period of time (e.g., Wednesday, Feb. 9, 2022) corresponding to the first feature constraint (e.g., the first time constraint). For example, the first response 558 may be generated to comprise “No, you have not received any emails from John Williamson last Wednesday, Feb. 9, 2022”. In an example, the second language model 556 may determine that there is no email from a contact named “John Williamson” in the first subset of data 546 based upon a determination that the first subset of data 546 is not indicative of an email (e.g., any email) that is associated with a value (of the second field “Sender”, for example) corresponding to “John Williamson”. Alternatively and/or additionally, in response to identifying one or more emails from a contact named “John Williamson” in the first subset of data 546, the second language model 556 may generate the first response 558 to include (i) an indication that the first email account has received one or more emails from John Williamson in the period of time (e.g., Wednesday, Feb. 9, 2022) corresponding to the first feature constraint (e.g., the first time constraint), and/or (ii) an indication of the one or more emails. In an example, the second language model 556 may determine that the first email account received an email from a contact named “John Williamson” in the period of time (e.g., Wednesday, Feb. 9, 2022) based upon a determination that the first subset of data 546 is indicative of an email that is associated with a value (of the second field “Sender”, for example) corresponding to “John Williamson”.

In some examples, the content system may provide a representation of the first response 558 for display on the first client device 500. For example, the representation of the first response 558 may be displayed via the first interface. FIG. 5F illustrates the representation (shown with reference number 560) of the first response 558 being displayed via the first interface 502. In some examples, the representation 560 may comprise (i) an indication that the first email account received an email (e.g., one email) from a contact named “John Williamson” during the period of time (e.g., Wednesday, Feb. 9, 2022) corresponding to the first feature constraint (e.g., the first time constraint) and/or (ii) an email item 564 corresponding to the email received by the first email account. For example, the email item 564 may comprise an indication of the contact (e.g., “John Williamson”), an indication of a subject line of the email (e.g., Focus Meeting next Wednesday), and/or an indication of a time (e.g., a date) associated with the email (e.g., “Feb. 9, 2022”). In some examples, in response to a selection of the email item 564, the email may be displayed via the first interface 502.

In some examples, the content system may provide a list of search results 566 associated with the first query 510 for display on the first client device 500. In some examples, the content system may perform a keyword search based upon the first query 510 to generate the list of search results 566. In some examples, the content system includes an email item in the list of search results 566 based upon a determination that an email corresponding to the email item is relevant to a keyword (e.g., “John Williamson”, “Wednesday”, etc.) in the first query 510.

It may be appreciated that using one or more of the techniques provided herein may provide for generating the first response 558 to the first query 510 more efficiently and/or quickly, such as due, at least in part, to providing the second language model 556 with the first subset of data 546 for use in generating the first response 558 such that the second language model 556 may generate the first response 558 based upon the first subset of data 546 (determined to be relevant to the first feature constraint, for example) without having to process an entirety of the first data structure 544. Thus, in accordance with some embodiments, the content system may provide a question-answering service that is more efficient and/or faster than some systems which may not perform filtering to identify a subset of relevant data (e.g., the first subset of data 546) and/or may instead provide an entirety of a data structure (e.g., an entirety of the first data structure 544) to a language model and/or task the language model with processing the entirety of the data structure in order to determine a response to a user query.

It may be appreciated that using one or more of the techniques provided herein may provide for generating the first response 558 to the first query 510 with increased accuracy, such as due, at least in part, to (i) using the first language model 528 to generate the first executable feature constraint determination command 530 and/or (ii) using the command execution module 536 to execute the first executable feature constraint determination command 530 to determine the first feature constraint 538. For example, some systems may task a language model and/or a natural language processing (NLP) algorithm to directly translate natural language of a query (e.g., the first query 510) to a feature constraint (e.g., a time constraint). Such systems may obtain incorrect feature constraint determinations since the task may require correct calculation of the feature constraint (e.g., concrete dates of the time constraint). For example, the language model and/or the NLP algorithm may be well-suited for extracting information from text, but may not be well-suited for calendar manipulation. Thus, in accordance with one or more of the techniques provided herein, the first feature constraint 538 (e.g., the first time constraint) and/or the first response 558 may be determined with increased accuracy by (i) using the first language model 528 to generate the first executable feature constraint determination command 530, and/or (ii) using the command execution module 536 to execute the first executable feature constraint determination command 530 to determine the first feature constraint 538 (without requiring the first language model 528 to perform calendar manipulation to determine the first feature constraint 538, for example). Thus, in accordance with some embodiments, the content system may provide a question-answering service that is more accurate than some systems which may attempt to use the language model and/or the NLP algorithm to directly determine a feature constraint (e.g., the first feature constraint 538). In some examples, the command execution module 536 has access (e.g., direct access) to calendar information, and/or may use the calendar information to determine the first feature constraint 538 (with increased accuracy, for example).

Alternatively and/or additionally, some systems may attempt to translate natural language of a query (e.g., the first query 510) to a feature constraint (e.g., a time constraint) using program-aided language models that produce complete programs which are executed to solve the query. Such systems may obtain incorrect feature constraint determinations due, at least in part, to the complete programs produced by the program-aided language models may be susceptible to hallucinations. Alternatively and/or additionally, the program-aided language models may require crafting chain of thought prompts describing solution steps in both natural language and programming language statements. Thus, in accordance with one or more of the techniques provided herein, the first feature constraint 538 (e.g., the first time constraint) and/or the first response 558 may be determined with increased accuracy, such as due, at least in part, to using the first language model 528 to generate the first executable feature constraint determination command 530 (e.g., the first executable feature constraint determination command 530, which may comprise a SQL statement and/or other type of statement, may be less susceptible to hallucinations than the complete programs produced by the program-aided language models, for example). Alternatively and/or additionally, techniques of the present disclosure may provide for reduced manual effort, such as due, at least in part, to not requiring the crafted chain of thought prompts required by the program-aided language models (whereas the set of demonstration information 524 may be less cumbersome and/or may be curated using less effort than the more complex chain of thought prompts).

Alternatively and/or additionally, using one or more of the techniques provided herein may provide for generating responses to queries (e.g., the first query 510) and/or determining feature constraints of queries with increased accuracy, as compared with some systems that attempt to use a pure-code module to translate natural language of a query (e.g., the first query 510) to a feature constraint (e.g., a time constraint), since the pure-code module may not work well for queries (e.g., natural language queries) given in free text.

Although the present disclosure provides examples in which the first feature corresponds to time, embodiments are contemplated in which the first feature is a different type of feature than time. In an example, the first feature corresponds to a contact and/or the first filter constraint corresponds to a first contact constraint. In an example, the first contact constraint may correspond to a first contact (e.g., “John Williamson”) to which the first query 510 is relevant. The first subset of data 546 may comprise data associated with emails that are associated with the first contact constraint (e.g., the first subset of data 546 may comprise one or more emails sent to and/or received from the first contact and/or may exclude emails that are not sent to or received from the first contact).

In an example, the first feature corresponds to a subject line and/or the first filter constraint corresponds to a first subject line constraint. In an example, the first subject line constraint may correspond to a first subject line term (e.g., “studysheet”) to which the first query 510 is relevant (e.g., the first query 510 may comprise “Please find all emails received in September that have a subject including the word ‘studysheet”). The first subset of data 546 may comprise data associated with emails that are associated with the first subject line constraint (e.g., the first subset of data 546 may comprise one or more emails that have subject lines comprising the term “studysheet” and/or may exclude emails that do not have subject lines comprising the term “studysheet”).

Other feature types of the first feature other than those explicitly listed herein are within the scope of the present disclosure.

Although the present disclosure provides examples in which the first data structure 544 and/or the first query 510 are associated with emails of the first email account, other types of data of the first data structure 544 are within the scope of the present disclosure. In an example, the first data structure 544 may comprise data associated with a pool of content items (e.g., at least one of articles, sets of text, images, audio, videos, etc.). For example, the first data structure 544 may comprise the pool of content items and/or data indicative of features associated with the pool of content items. In an example, the set of fields of the first data structure 544 may comprise at least one of a field “Publication Time” (e.g., the field “Publication Time” may be indicative of a time at which a content item of the pool of content items was published), a field “Publisher” (e.g., the field “Publisher” may be indicative of a publisher of a content item), a field “Author” (e.g., the field “Author” may be indicative of one or more authors of a content item), etc. The set of fields may be populated with values for content items of the pool of content items. For example, the field “Publication Time” may be populated with a first publication time for a first content item, a second publication time for a second content item, etc.

In an example, the first feature corresponds to publication time and/or the first filter constraint corresponds to a first publication time constraint. In an example, the first publication time constraint may correspond to a period of time to which the first query 510 is relevant (e.g., the first query 510 may comprise “Please provide news articles published in September” and/or the first publication time constraint may correspond to September). The first subset of data 546 may comprise data associated with content items (e.g., news articles) that were published in the period of time (e.g., the first subset of data 546 may comprise one or more content items that were published in September and/or may exclude content items that were not published in September).

In an example, the first feature corresponds to an author and/or the first filter constraint corresponds to a first author constraint. In an example, the first author constraint may correspond to an author to which the first query 510 is relevant (e.g., the first query 510 may comprise “Please provide news articles written by John Adams” and/or the first author constraint may correspond to an author named “John Adams”). The first subset of data 546 may comprise data associated with content items (e.g., news articles) that were authored by the author and/or may exclude content items that were not authored by the author).

Other types of data of the first data structure 544 other than those explicitly listed herein are within the scope of the present disclosure.

It may be appreciated that the disclosed subject matter may assist a user in determining an answer to a question and/or request posed by a user query (e.g., the first query 510).

Implementation of at least some of the disclosed subject matter may lead to benefits including a reduction in screen space and/or an improved usability of a display (e.g., of a client device) (e.g., as a result of providing the first response 558 that may represent an answer to a question and/or request posed by the first query 510, wherein the user may not be required to navigate through multiple items (e.g., email items), multiple web pages and/or open various tabs and/or windows to access the requested information and/or the user may not be required to navigate away to a different page, and/or manually sift through online information, thereby saving time and effort, etc.).

Alternatively and/or additionally, implementation of at least some of the disclosed subject matter may lead to benefits including less manual effort (e.g., as a result of generating the first response 558 automatically, wherein manual editing to produce the first response 558 is not required).

In some examples, the first client device 500 is configured to display a menu listing one or more features (e.g., selectable features) of the content system. The one or more features may comprise at least one of a search feature, a content feature, a messaging feature, a social media feed feature, an email feature, etc. In an example, in response to a selection of the search feature, the search feature may provide one or more resources for using a search engine of the content system to search for content. In an example, in response to a selection of the content feature, the content feature may provide one or more resources for displaying and/or engaging with content items (e.g., videos, images, audio files, news articles, etc.). In response to a selection of the messaging feature, the messaging feature may provide one or more resources (e.g., data, an interface, etc.) for displaying and/or facilitating messaging conversations (e.g., private messaging conversations and/or public messaging conversations) between users of the content system (e.g., users of the content system may send messages to each other using the messaging feature of the content system). In response to a selection of the social media feed feature, the social media feed feature may provide one or more resources (e.g., data, an interface, etc.) for displaying social media posts and/or comments on a social media platform. In response to a selection of the email feature, the email feature may provide one or more resources (e.g., data, an interface such as the first interface 502, etc.) for displaying emails and/or allowing the first user to compose new emails and/or reply to emails. In some examples, the client device is configured to display a content platform application summary that can be reached directly from the menu, wherein the content platform application summary displays a limited list of data offered within the one or more features. In some examples, each of the data in the limited list of data is selectable to launch the respective feature (of the one or more features) and enable the selected data to be seen within the respective feature. In some examples, the content platform application summary is displayed while the one or more features are in an un-launched and/or unopened state.

In some examples, one, some or all acts of the present disclosure are implemented using a cognitive system (e.g., a cognitive computing system) of the content system. The cognitive system may comprise the first language model 528, the second language model 556, and/or a question-answering pipeline (comprising the first language model 528, the command execution module 536, the relevant data identification module 542 and/or the second language model 556, for example) for providing responses (e.g., the first response 558) to user queries (e.g., the first query 510). A cognitive system may be a specialized computer system, and/or a set of computer systems, configured with hardware and/or software logic (in combination with hardware logic upon which the software executes) to emulate human cognitive functions. The cognitive system may apply human-like characteristics to conveying and manipulating ideas which, when combined with the inherent strengths of digital computing, may solve problems with high accuracy and resilience on a large scale. The cognitive system may perform one or more computer-implemented cognitive operations that approximate a human thought process as well as enable people and machines to interact in a more natural manner so as to extend and magnify human expertise and cognition. The cognitive system may comprise artificial intelligence logic, such as NLP based logic, for example, and machine learning logic, which may be provided as specialized hardware, software executed on hardware, or any combination of specialized hardware and software executed on hardware. The logic of the cognitive system implements the cognitive operation(s), examples of which include, but are not limited to, question answering, identification of related concepts within different portions of content in a corpus, intelligent search algorithms, such as Internet web page searches, for example, medical diagnostic and treatment recommendations, and other types of recommendation generation, e.g., items of interest to a particular user, potential new contact recommendations, or the like.

In some examples, at least some of the disclosed subject matter may be implemented on a client device, and in some examples, at least some of the disclosed subject matter may be implemented on a server (e.g., hosting a service accessible via a network, such as the Internet).

Embodiments are contemplated in which (i) the first language model 528 is used to generate an output indicative of the first feature constraint 538 based upon the first set of information 514 comprising the first query 510, and/or (ii) the output indicative of the first feature constraint 538 is used by the relevant data identification module 542 to identify the first subset of (relevant) data 546.

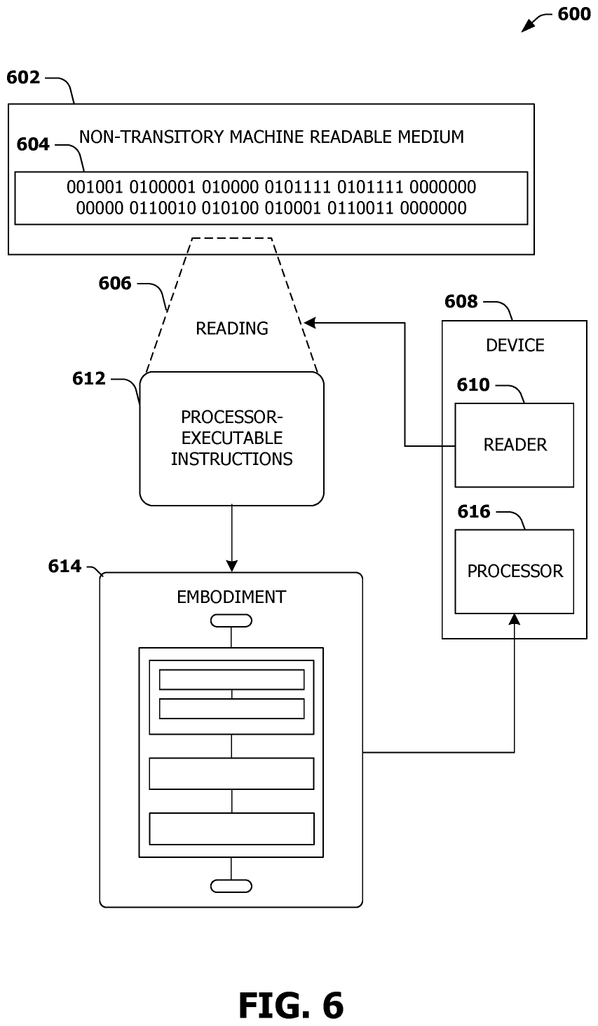

FIG. 6 is an illustration of a scenario 600 involving an example non- transitory machine readable medium 602. The non-transitory machine readable medium 602 may comprise processor-executable instructions 612 that when executed by a processor 616 cause performance (e.g., by the processor 616) of at least some of the provisions herein (e.g., embodiment 614). The non-transitory machine readable medium 602 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disc (CD), digital versatile disc (DVD), or floppy disk). The example non-transitory machine readable medium 602 stores computer-readable data 604 that, when subjected to reading 606 by a reader 610 of a device 608 (e.g., a read head of a hard disk drive, or a read operation invoked on a solid-state storage device), express the processor-executable instructions 612. In some embodiments, the processor-executable instructions 612, when executed, cause performance of operations, such as at least some of the example method 400 of FIG. 4, for example. In some embodiments, the processor-executable instructions 612 are configured to cause implementation of a system, such as at least some of the example system 501 of FIGS. 5A-5F, for example.

### 3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer and/or machine readable media, which if executed will cause the operations to be performed. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

1. A method, comprising:
receiving a time-sensitive query;
using a first language model to generate an executable time constraint determination command, comprising a first function corresponding to a data management system language, based upon a set of information comprising the time-sensitive query;
executing the executable time constraint determination command to determine a time constraint associated with the time-sensitive query;
analyzing a data structure based upon the time constraint to identify a subset of data, of the data structure, relevant to the time constraint; and
generating a response to the time-sensitive query based upon the subset of data.

2. The method of claim 1, comprising:
generating, based upon one or more characteristics of the data structure, a data structure template, wherein at least one of:
the set of information comprises the data structure template; or
the method comprises training a language model using the data structure template to generate the first language model.

3. The method of claim 1, wherein generating the response comprises:
using a second language model to generate the response based upon:
the subset of data; and
the time-sensitive query.

4. The method of claim 3, wherein:
the second language model is the same as the first language model.

5. The method of claim 3, wherein:
the second language model is different than the first language model.

6. The method of claim 1, comprising:
displaying the response via a client device.

7. The method of claim 1, wherein:
the set of information comprises a current date.

8. The method of claim 1, wherein:
the data structure comprises a relational database.

9. A non-transitory machine-readable medium having stored thereon processor-executable instructions that when executed cause performance of operations, the operations comprising:
receiving a feature-sensitive query;
using a first language model to generate an executable feature constraint determination command, comprising a first function corresponding to a data management system language, based upon a set of information comprising the feature-sensitive query;
executing the executable feature constraint determination command to determine a feature constraint associated with the feature-sensitive query;
analyzing a data structure based upon the feature constraint to identify a subset of data, of the data structure, relevant to the feature constraint; and
generating a response to the feature-sensitive query based upon the subset of data.

10. The non-transitory machine-readable medium of claim 9, the operations comprising:
generating, based upon one or more characteristics of the data structure, a data structure template, wherein at least one of:
the set of information comprises the data structure template; or
the operations comprise training a language model using the data structure template to generate the first language model.

11. The non-transitory machine-readable medium of claim 9, wherein generating the response comprises:
using a second language model to generate the response based upon:
the subset of data; and
the feature-sensitive query.

12. The non-transitory machine-readable medium of claim 11, wherein:
the second language model is the same as the first language model.

13. The non-transitory machine-readable medium of claim 11, wherein:
the second language model is different than the first language model.

14. The non-transitory machine-readable medium of claim 9, the operations comprising:
displaying the response via a client device.

15. The non-transitory machine-readable medium of claim 9, wherein:
the set of information comprises a current date.

16. The non-transitory machine-readable medium of claim 9, wherein:
the data structure comprises a relational database.

17. A computing device comprising:
a processor; and
memory comprising processor-executable instructions that when executed by the processor cause performance of operations, the operations comprising:
receiving a feature-sensitive query;
using a first language model to generate an executable feature constraint determination command, comprising a first function corresponding to a data management system language, based upon a set of information comprising the feature-sensitive query;
executing the executable feature constraint determination command to determine a feature constraint associated with the feature-sensitive query;
analyzing a data structure based upon the feature constraint to identify a subset of data, of the data structure, relevant to the feature constraint; and
generating a response to the feature-sensitive query based upon the subset of data.

18. The computing device of claim 17, the operations comprising:
generating, based upon one or more characteristics of the data structure, a data structure template, wherein at least one of:
the set of information comprises the data structure template; or
the operations comprise training a language model using the data structure template to generate the first language model.

19. The computing device of claim 17, wherein generating the response comprises:
using a second language model to generate the response based upon:
the subset of data; and
the feature-sensitive query.

20. The computing device of claim 17, the operations comprising:
displaying the response via a client device.
